(19) United States
(12) Patent Application Publication
(10) Pub. No.: US 2010/0111263 A1
(43) Pub. Date: May 6, 2010

(54) MODULAR HANDLE FOR DIGITAL X-RAY DETECTORS

(75) Inventors: John Lamberty, Oconomowoc, WI (US); Beilei Wang, Waukesha, WI (US); James Zhengshe Liu, Glenview, IL (US)

Correspondence Address: Ramirez & Smith, P.O. Box 341179, Austin, TX, 78734, US

(73) Assignee: GENERAL ELECTRIC COMPANY, Schenectady, NY (US)

(21) Appl. No.: 12/261,777

(22) Filed: Oct. 30, 2008

(51) Int. Cl. H01J 31/50; H01J 5/02

(52) U.S. Cl. 378/189; 250/239

(57) ABSTRACT

Systems, methods and apparatus are provided through which in some implementations a portable digital X-ray detector includes a modular handle that is removeable from a housing of the detector, the modular handle includes component(s) that perform functions that are specific to a number of portable digital X-ray detectors, such as data communication with external devices and/or power conditioning, and the housing of the detector includes the pixel array and component(s) that perform functions that are common to the pixel array. In some implementations, the modular handle includes an interface to the housing to support data communications and/or power supply with the component(s) in the housing and the housing also includes an interface that operably couples to the modular handle.

### RELATED APPLICATION

This application is related to copending U.S. application Ser. No. 12/169,201 filed Jul. 8, 2008 having attorney docket number GE.0144 and entitled “MULTI-PURPOSE DOCKING APPARATUS OF A DIGITAL X-RAY DETECTOR.”

This application is related to copending U.S. application Ser. No. 12/177,877 filed Jul. 22, 2008 having attorney docket number GE.0145 and entitled “BATTERY CHARGING APPARATUS OF A WIRELESS DIGITAL X-RAY DETECTOR.”

### FIELD

This invention relates generally to digital X-ray detectors, and more particularly to modularity of digital X-ray detector components.

### BACKGROUND

Portable digital X-ray detectors include an X-ray imaging device. The X-ray imaging device includes a pixel array that captures X-ray electromagnetic energy and converts the X-ray electromagnetic energy to electrical signals. Each portable digital X-ray detector also includes electrical components that read the electrical signals from the pixel array and that scrub the pixel array at a particular periodicity, in which a complete image from the entire pixel array is captured. Each portable digital X-ray detector also includes a communication component that transfers each complete image from the detector to an outside device, such as an image acquisition station or a mobile digital X-ray imaging system. The transfer is performed at a specific frame rate.

The communication device and the pixel array are both tightly coupled to each other and designed to operate within very particular and specific operating parameters of each other. The design of a communication device of a particular portable digital X-ray detector is modified for each particular pixel array or portable digital X-ray detector.

### BRIEF DESCRIPTION

The above-mentioned shortcomings, disadvantages and problems are addressed herein, which will be understood by reading and studying the following specification.

In one aspect, an apparatus includes an imaging device mounted inside a housing and a handle that is removeably mounted to the housing. The handle contains a plurality of electronic components operably coupled to the imaging device. In the apparatus, components that perform functions that are specific to X-ray detectors are located in the handle and components that perform functions that are common to each X-ray detector are located in the housing, thus the handle is interchangeable with other handles that include components that perform functions that are specific to X-ray detectors. In some implementations, the handle includes at least one wireless communication interface, at least one antennae, a switch regulation board (SRB), at least one battery and/or at least one battery management component for wireless applications. In some implementations, the handle includes a touchspot for power and data communication during docking. In some implementations, the handle includes an Ethernet transceiver and a tether for a fixed detector in wired applications. This modular structure reduces development complexity and effort.

In another aspect, a digital X-ray detector handle includes a face that is operable to be removeably mounted to a housing of a digital X-ray detector. The digital X-ray detector handle also includes a specific interface component that is operable to communicate with electronic components in the housing of the digital X-ray detector in regards to application-dependent functions of the electronic components. The digital X-ray detector handle also includes a power interface that is operable to provide electrical power to electronic components in the housing of the digital X-ray detector. The digital X-ray detector handle also includes a specific interface component that is operable to communicate with electronic components not in the housing of the digital X-ray detector in regards to application-independent functions of the electronic components.

In yet another aspect, a portable digital X-ray detector includes a housing having an inside and an outside, an imaging device mounted inside the housing, an end-cap mounted to an end of the housing. The portable digital X-ray detector also includes a handle that is removeably mounted to an end that is opposite to the end-cap of the housing, the handle having a recess that passes completely through the handle. The portable digital X-ray detector also includes a plurality of electronic components operably coupled to the imaging device in which a portion of the plurality of electronic components that are dependent on the pixel array are mounted in the housing and in which a portion of the plurality of electronic components that are independent of the pixel array are mounted in the handle.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a digital X-ray detector system having a modular configuration, according to an implementation;

FIG. 2 is an isometric diagram of a digital X-ray detector system having a modular configuration, according to an implementation;

FIG. 3 is an isometric diagram of a digital X-ray detector system having a modular configuration of a handle removeably attached to a digital X-ray detector, according to an implementation;

FIG. 4 is a block diagram of a digital X-ray detector handle for fixed applications that has a modular configuration, according to an implementation;

FIG. 5 is a block diagram of a digital X-ray detector handle having a wireless communication path, according to an implementation;

FIG. 6 is a block diagram of a digital X-ray detector handle having a wireless communication path and a wired communication path, according to an implementation;

FIG. 7 is an isometric diagram of a digital X-ray detector handle having electrical contact apparatus for data and power communication with a digital X-ray detector, according to an implementation;

FIG. 8 is a block diagram of a digital X-ray detector handle having touchspots for data and power communication, according to an implementation;

FIG. 9 is an isometric diagram of a digital X-ray detector handle having a detector case, according to an implementation;

FIG. 10 is a flowchart of a method of managing electrical power, performed by a digital X-ray detector handle, according to an implementation; and

FIG. 11 is a flowchart of a method of managing data communication, performed by a digital X-ray detector handle, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into four sections. In the first section, a system level overview is described. In the second section, implementations of apparatus are described. In the third section, particular implementations of methods are described. Finally, in the fourth section, a conclusion of the detailed description is provided.

### System Level Overview

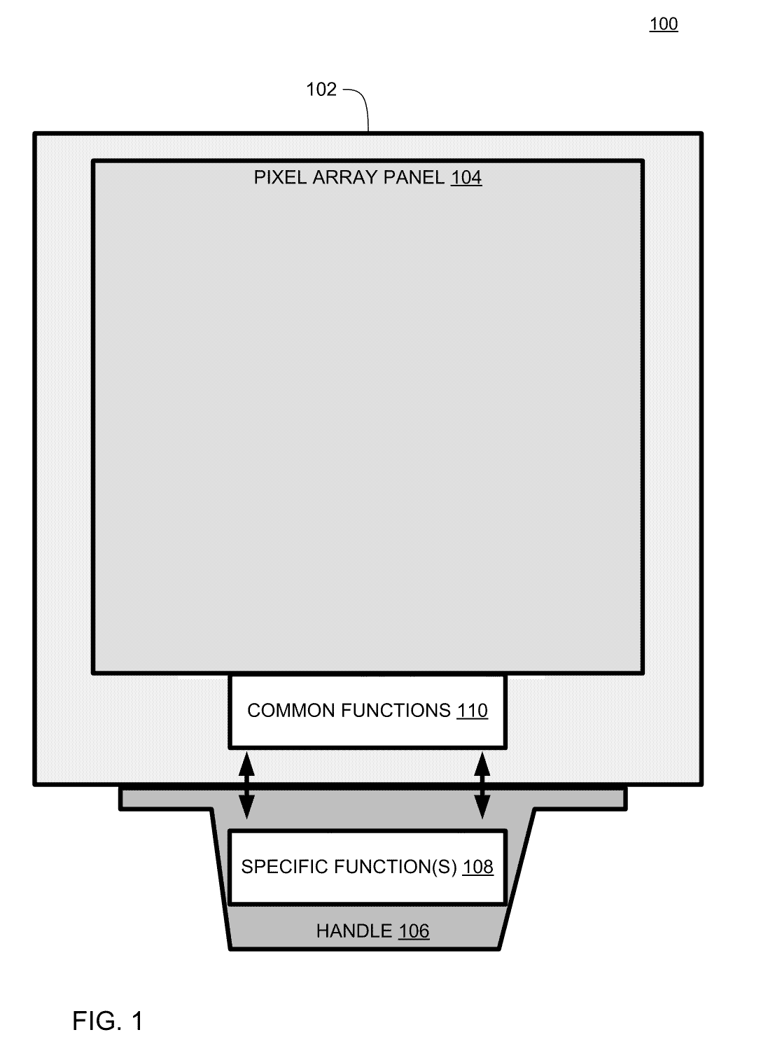

FIG. 1 is a block diagram of an overview of a digital X-ray detector system 100 having a modular configuration. A system level overview of the operation of an implementation is described in this section of the detailed description. Digital X-ray detector system 100 provides a modular configuration for the electrical components for the digital X-ray detector system 100 in which the components that perform functions that are closely related to the function of the image capturing are located in the housing of the system and the components that perform functions that are specific among digital X-ray detector systems are located in the modular handle. The modular configuration of digital X-ray detector system 100 simplifies the design, manufacture, testing and maintenance of the digital X-ray detector system 100.

Digital X-ray detector system 100 includes a housing 102 having an inside and an outside. The housing 102 is also known as a body. Digital X-ray detector system 100 also includes an X-ray imaging device (not shown) that includes a pixel array panel 104 and/or other components of a digital X-ray detector. The X-ray imaging device is mounted inside of the housing 102.

Digital X-ray detector system 100 also includes a handle 106 that is mounted to the housing 102. In some implementations, the handle 106 is removeably mounted to the housing 102. The handle 106 includes at least one electronic component 108 that is mounted inside the handle 106. The electronic component(s) 108 are operably coupled to the pixel array panel 104 through the imaging device. The electronic component(s) 108 are operable to couple an image acquisition station (not shown) or other devices that are external to the digital X-ray detector system 100. The coupling between the electronic component(s) 108 and the image acquisition station can include electrical power coupling in which the digital X-ray detector system 100 receives electrical power from the image acquisition station. The coupling between the electronic components and the image acquisition station can also include data communication coupling in which data is exchanged between the electronic component(s) 108 and the image acquisition station.

In a key aspect of digital X-ray detector system 100, the electronic component(s) 108 perform functions that are unrelated (or independent) of the pixel array panel 104. Examples of functions provided by the electronic component(s) 108 that are independent of the pixel array panel 104 include data communication with external devices and receiving power from external source and distributing power to the pixel array panel, the distribution including battery charging/monitoring in implementations that include a battery in the handle 106. The logic involved in data communication with external devices is independent of the function of the pixel array panel 104. The logic or function of the digital X-ray detector system 100 that is independent of the pixel array panel 104 is performed by the electronic component(s) 108 in the handle 106. Furthermore, electronic components 110 that are related (or dependent) on the common functions of the pixel array panel 104 in the X-ray imaging device are mounted in the housing 102. Examples of functions provided by the electronic components 110 that are dependent or related to the functions of the pixel array panel are converting X-ray energy into light and then converting the light into an analog electrical signal, a scan module selecting a specific row of diode pixel array to read, a data module amplifying and digitizing the analog electrical signal, a motherboard transmitting the digitized data from the data module to a communication module, the motherboard and software/firmware components managing the detector system including power management, a panel support and the housing 102 providing temperature monitoring mechanical shock detection and recording error handling, protecting the pixel panel 104 and electronics from loading, impact, drop etc. Digital X-ray detector system 100 reduces cost in the design of manufacture, testing and maintenance of digital X-ray detector system 100 because the communication function and the detector function of digital X-ray detector system 100 are located in separate portions (i.e. handle 106 and housing 102) of the digital X-ray detector system 100. Thus, the functions of the digital X-ray detector system 100 that are independent of the imaging function and the functions of the digital X-ray detector system 100 that are specific to various digital X-ray detector systems can be designed, manufactured, tested and maintained with a higher degree of modularity, which provides efficiencies in the engineering, manufacture, testing and maintenance of the digital X-ray detector system 100. Different digital X-ray detector systems can be built with a single detector body and different handles. Therefore, digital X-ray detector system 100 reduces the design, manufacture, verification, and maintenance cost of digital X-ray detector system 100, which reduces the cost of the digital X-ray detector systems.

While the digital X-ray detector system 100 is not limited to any particular housing 102, pixel array panel 104, handle 106 and electronic component(s) 108 and 110; for sake of clarity simplified housing 102, pixel array panel 104, handle 106 and electronic component(s) 108 and 110 are described.

The electronic components 108 and 110 can be embodied as computer hardware circuitry or as a computer-readable program, or a combination of both. More specifically, in a computer-readable program implementation, the programs can be structured in an object-orientation using an object-oriented language such as Java, Smalltalk or C++, and the programs can be structured in a procedural-orientation using a procedural language such as C language.

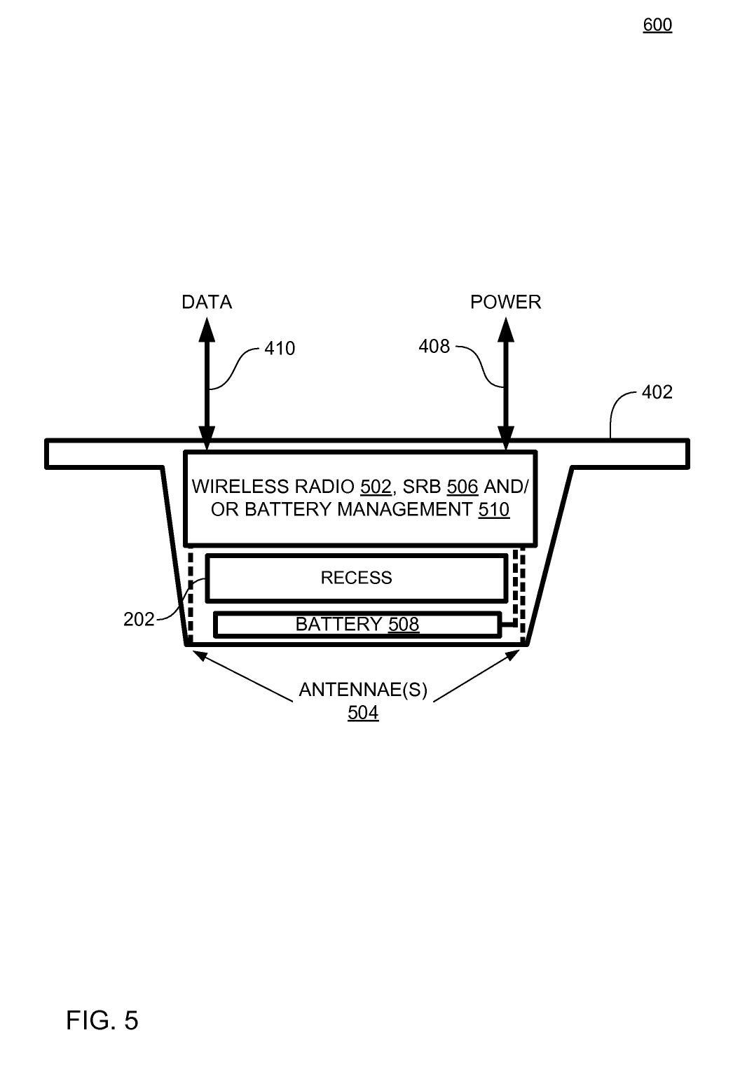

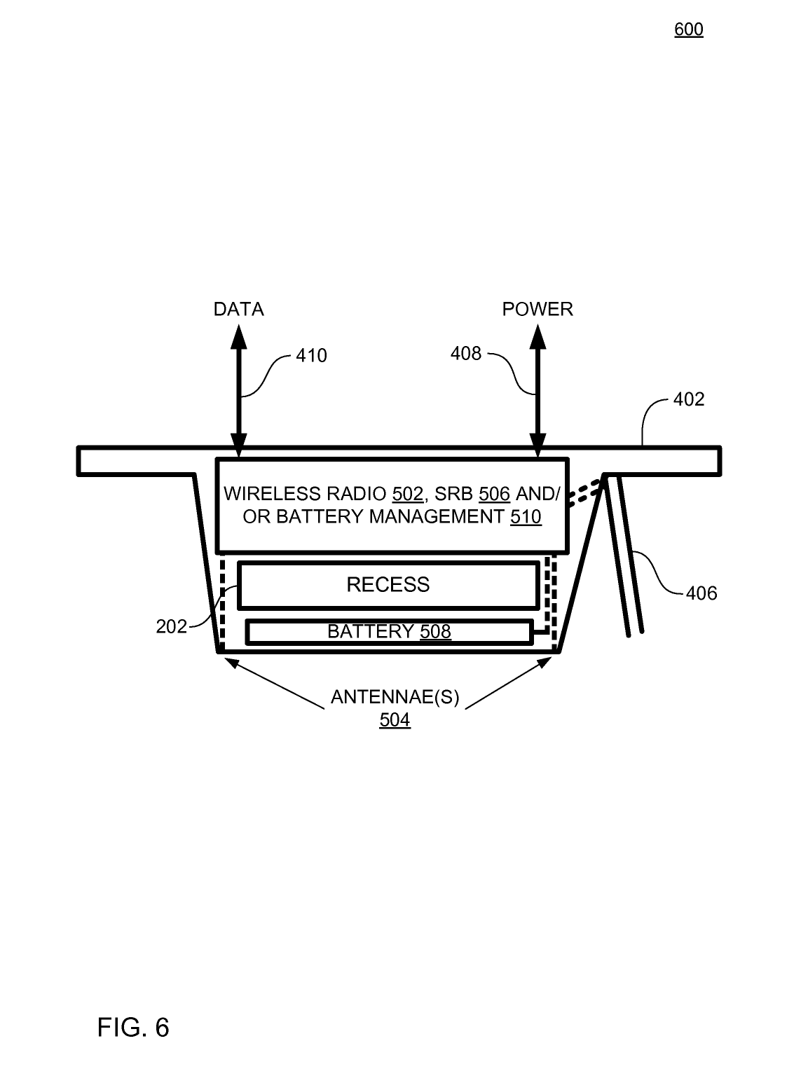

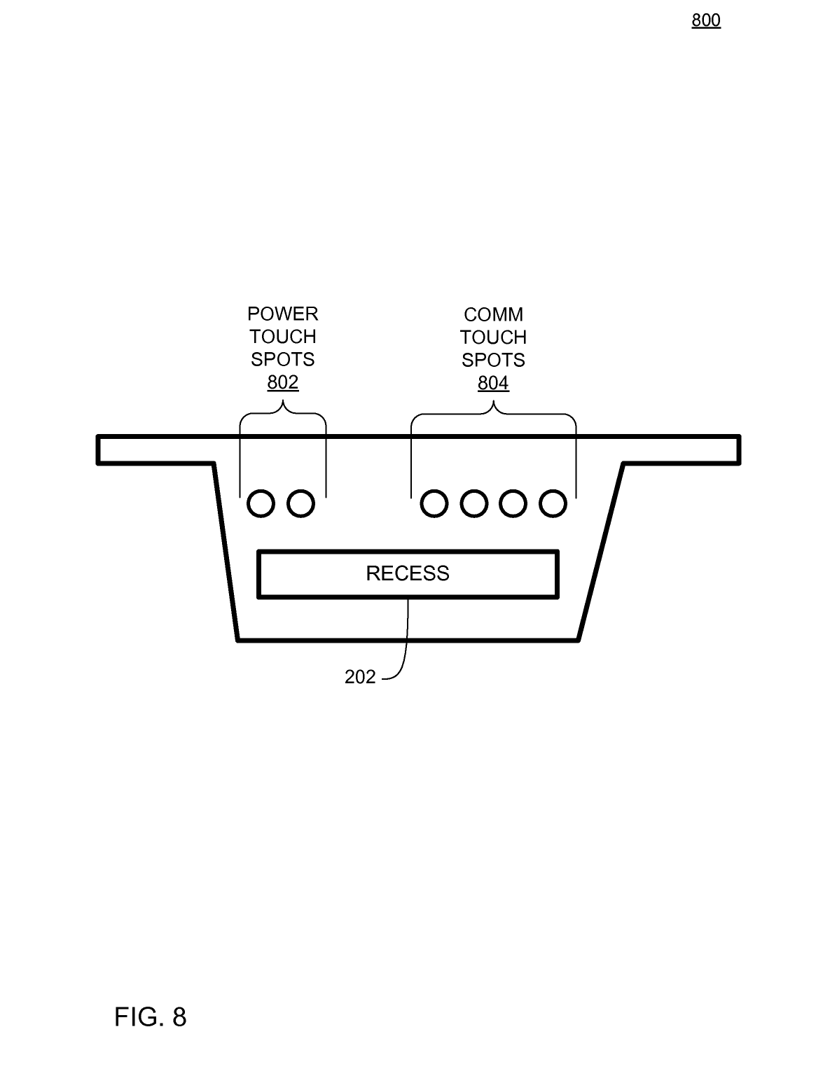

In some implementations, the handle 106 includes at least one wireless communication interface, at least one antennae, a switch regulation board (SRB), at least one battery and/or at least one battery management component for wireless applications such as described in FIG. 5 and FIG. 6. In some implementations, the handle includes a touchspot for power and data communication during docking. In some implementations, the handle includes an Ethernet transceiver and a tether for a fixed detector in wired applications, such as shown in FIG. 8.

### Apparatus

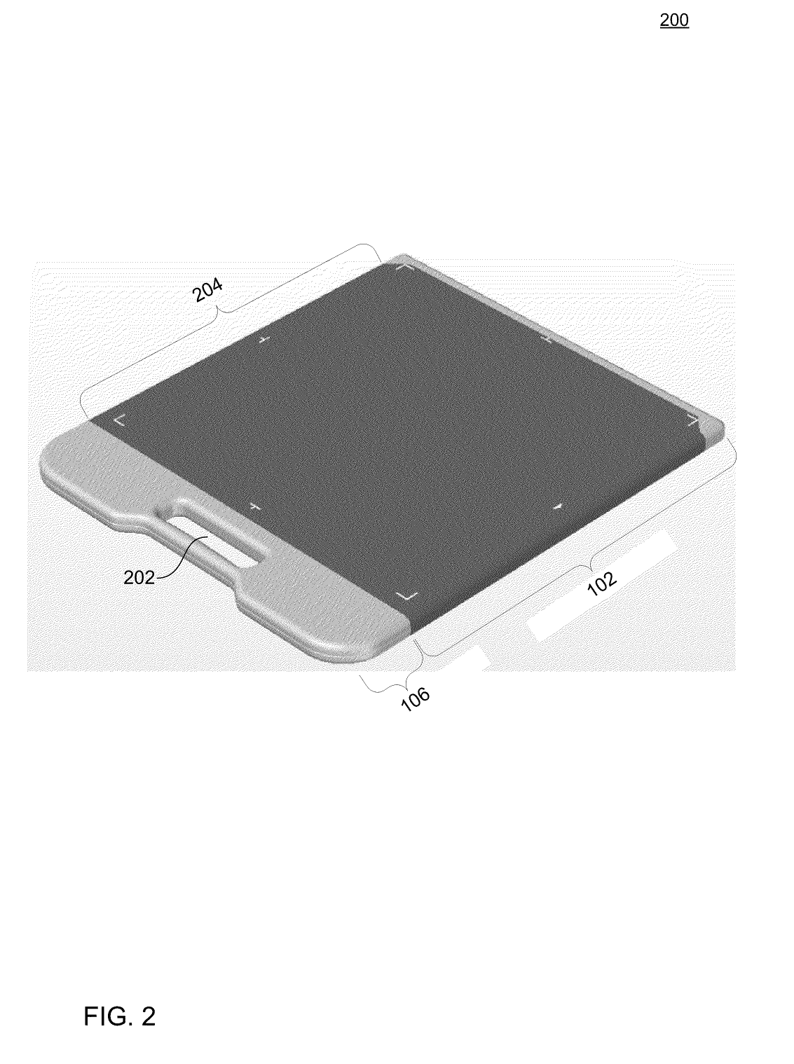

FIG. 2 is an isometric diagram of a digital X-ray detector system 200 having a modular configuration. Some implementations of the handle 106 of the digital X-ray detector system 200 include a recess 202. In some implementations such as shown in FIG. 2, the recess 202 passes completely through the handle 106. In some implementations (not shown), the recess 202 does not pass completely through the handle 106, but rather the recess 202 is an area of the handle 106 that is thinner than surrounding areas of the handle 106. The recess 202 provides convenient carriage by a human of the digital X-ray detector system 200.

Some implementations of digital X-ray detector system 200 include a detector case 204, such as a carbon fiber sleeve. The carbon fiber sleeve is electronically conductive in x and y directions. The x and y directions are perpendicular to the expected direction of an X-ray beam that enters the pixel array from an X-ray source. Thus, the carbon fiber sleeve provides electromagnetic (EMC) shielding. On the other hand, the carbon fiber sleeve has low X-ray attenuation and is lightweight. The detector case 204 covers all of the pixel array panel (not shown). The detector case 204 provides physical protection to the pixel array panel while allowing X-ray electromagnetic energy to pass through the pixel array panel.

In some implementations, the sleeve 204 is fixedly attached to the handle 106. In that implementation, the digital X-ray detector slides into the sleeve 204 and the handle 106 couples to the housing. As a result, the handle 106 is removeably coupled to the housing 102 through the detector case 204 that extends over the housing 102.

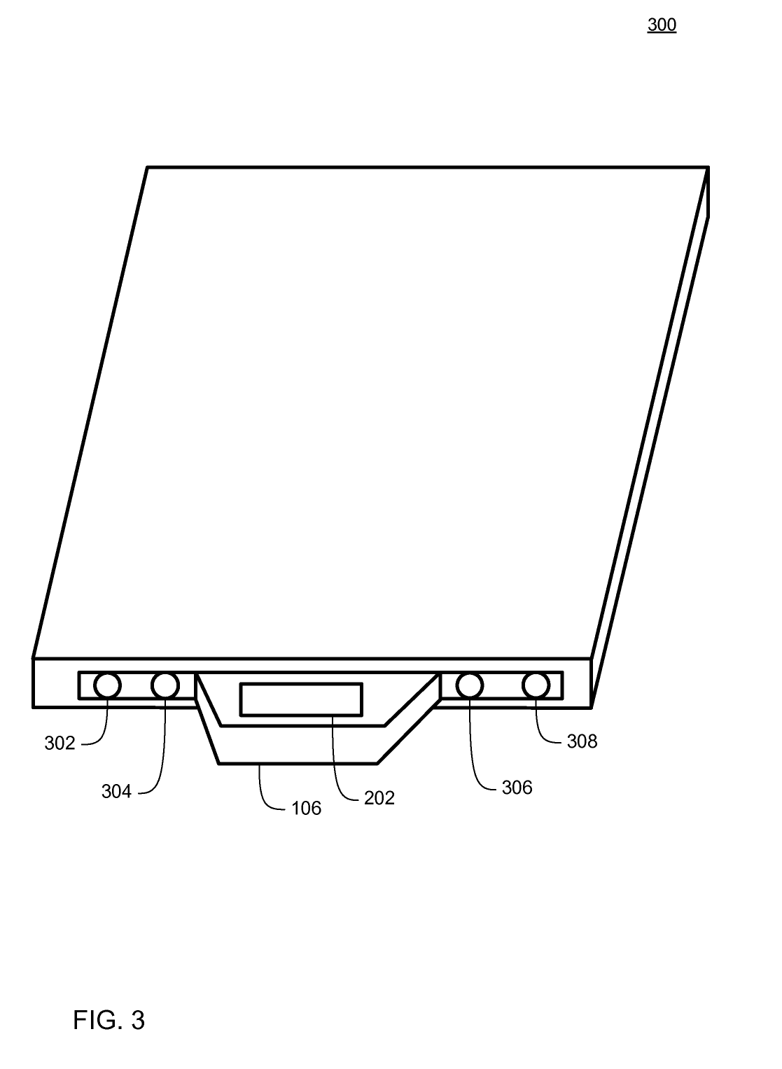

FIG. 3 is an isometric diagram of a digital X-ray detector system 300 having a modular configuration of a handle removeably attached to a digital X-ray detector. Some implementations of a handle 106 of the digital X-ray detector system 300 include a recess 202. In some implementations such as shown in FIG. 3, the recess 202 passes completely through the handle 106. The recess 202 provides convenient carriage by a human of the digital X-ray detector system 300.

In the implementation shown in FIG. 3, the handle 106 can be removeably mounted to the housing by at least one screw 302, 304, 306 and/or 308. In some implementations of the digital X-ray detector system 300 that are not shown, the handle 106 can be removeably mounted to the housing by at least one clamp.

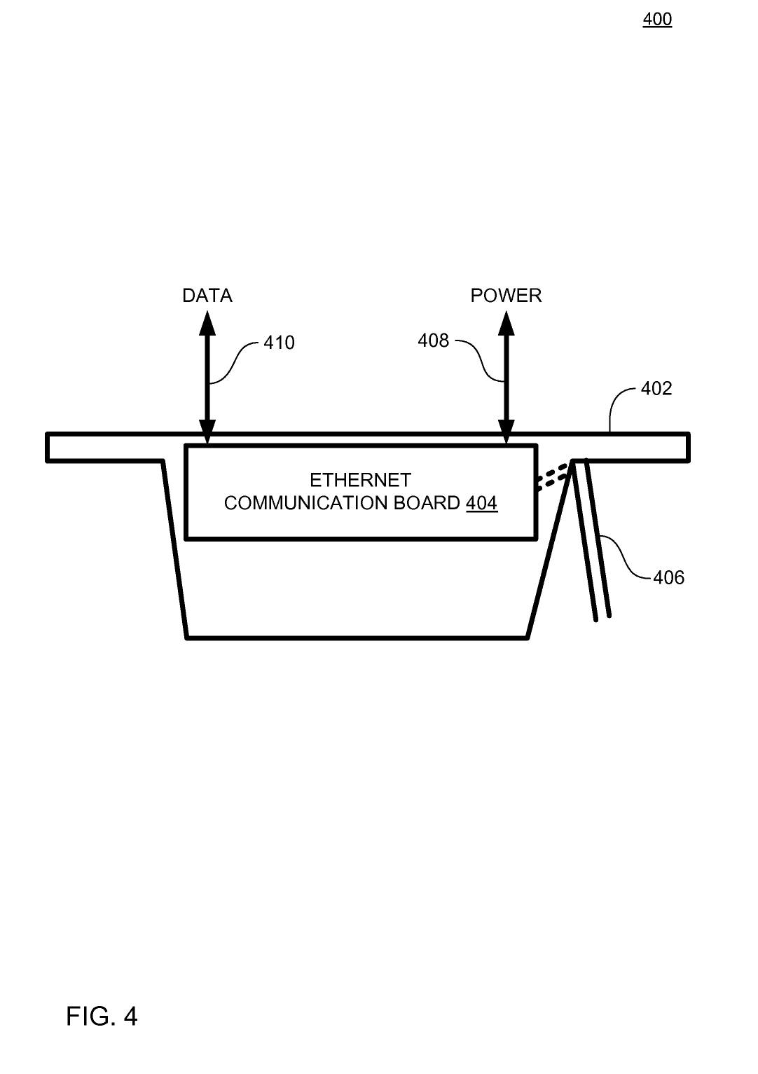

FIG. 4 is a block diagram of a digital X-ray detector handle 400 for fixed applications that has a modular configuration. The digital X-ray detector handle 400 is one example or implementation of the handle 106 in FIG. 1 and FIG. 2 above.

The digital X-ray detector handle 400 also includes a specific interface component 404 that can communicate with electronic components in the housing of the digital X-ray detector. In the example shown in FIG. 4, the specific interface component 404 is a 10 gigabit (GB) Ethernet communication board. In other implementations, different Ethernet communication boards are used for the specific interface component 404.

The communication is one example of a function that can be performed by the digital X-ray detector handle 400 that is specific among a variety of digital X-ray detectors. The specific interface component 404 can couple an image acquisition station (not shown) or other devices that are external to the digital X-ray detector handle 400. The coupling between the specific interface component 404 and the image acquisition station can include a tether 406 that includes electrical power coupling in which the digital X-ray detector handle 400 receives electrical power from the image acquisition station. The tether 406 between the specific interface component 404 and the image acquisition station can also include data communication coupling in which data is exchanged between the specific interface component 404 and the image acquisition station. For fixed-room applications of a digital X-ray detector system, the digital X-ray detector handle 400 provides high data transfer rate, reliable data communication and convenience of moving the digital X-ray detector system between a X-ray table and a X-ray wall-stand. In some configurations, two digital X-ray detector systems are deployed, one digital X-ray detector system for use at the X-ray table and one digital X-ray detector system for use at the X-ray wall-stand. The fixed room applications can have various configurations. In one implementation, only one detector is deployed, and the singular detector is moved between a table and a wall-stand in a room. In another implementation, two detectors are deployed, one detector dedicated for use at an X-ray table and another detector dedicated for use at an X-ray wall-stand. In yet another implementation, three detectors are deployed, one detector dedicated for use at an X-ray table, another detector dedicated for use at an X-ray wall-stand and a third detector dedicated for use at a tabletop or chair, the chair often being referred to as a digital cassette or flying detector.

The digital X-ray detector handle 400 is one of several different standard detector handles. For a specific detector, a handle is selected according to the requirements of the intended applications. For a detector that requires high frame rate such as fluoroscopy, a fast communication channel such as 10 G Ethernet 404 may be required and a tether 406 containing both detector power and communication channels is used. For portable applications, a Gigabit Ethernet (not shown) may be implemented. In this case, the 10 gigabit (GB) Ethernet® communication board inside the handle is replaced by a Gigabit Ethernet board. In other implementations, 100 BT Ethernet is implemented. The benefits of using a specific interface component 404 with lower speed includes not only a lower cost, but also lower power consumption and lower heat generation.

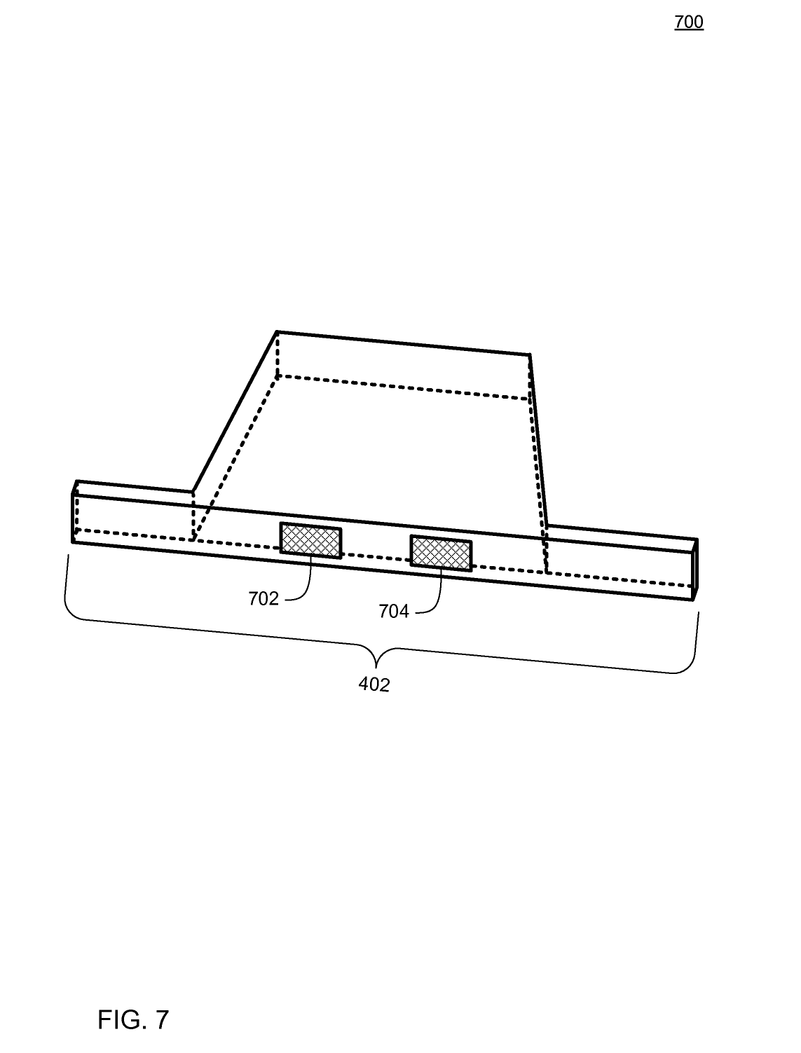

Some implementations of the digital X-ray detector handle 400 also include a power interface. The power interface is operable to provide electrical power to electronic components in the housing of the digital X-ray detector. In some implementations, the power interface 408 is located on the face 402. When the digital X-ray detector handle 400 is mounted on a housing of a digital X-ray detector, the power interface is flush to the housing in a position that provides direct physical contact to the housing and provides operative electrical coupling 408 to the housing. The power interface 408 is also shown in FIG. 7.

Some implementations of the digital X-ray detector handle 400 also include a specific interface component 410. The specific interface component 410 is operable to communicate with electronic components in the housing of the digital X-ray detector in regards to application-dependent functions of the electronic components. The specific interface component 410 is also shown in FIG. 7.

In some implementations, the specific interface component 410 is located on the face 402. When the digital X-ray detector handle 400 is mounted on a housing of a digital X-ray detector, the specific interface component 410 is flush to the housing in a position that provides direct physical contact and provides operative electrical coupling to the housing.

FIG. 5 is a block diagram of a digital X-ray detector handle 500 having a wireless communication path. The digital X-ray detector handle 500 is one example or implementation of the handle 106 in FIG. 1 and FIG. 2 above. The digital X-ray detector handle 500 includes at least one wireless communication interface 502, at least one antennae 504, a switch regulation board (SRB) 506, at least one battery 508 and/or at least one battery management component 510. The SRB 506 converts a single power input that is received from the battery 508 to a plurality power inputs to the detector motherboard and other modules. The batterie(s) 508 are operably coupled to the wireless communication interface(s) 502, the switch regulation board(s) 506, and/or the battery management component(s) 510 or other electrical components in the digital X-ray detector handle 500. The battery management component 510 monitors the charge level and recharging of the batterie(s) 508. The antennae(s) 504 are operably coupled to the wireless communication interface(s) 502.

Note the absence of electrical power coupling (e.g. 406 in FIG. 4) to receive electrical power and/or data communication from an external source. The lack of electrical and data coupling to an external source provides a highly portable and mobile digital X-ray detector handle that can be coupled to a digital X-ray detector and placed in a wide variety of locations of imaging.

FIG. 6 is a block diagram of a digital X-ray detector handle 600 having a wireless communication path and a wired communication path. The digital X-ray detector handle 600 is one example or implementation of the handles in FIGS. 1, 2 and 5 above. The digital X-ray detector handle 600 includes a tether 406 in which the digital X-ray detector handle 600 receives electrical power from an external device such as an image acquisition station. The tether 406 between the specific interface component 404 and the image acquisition station can also include data communication coupling in which data is exchanged between the specific interface component 404 and the external device. The presence of both wireless and wired connections to an image acquisition station provides flexibility for operation in a variety applications. Flexibility in applications of the digital X-ray detector handle 600 can be very helpful because the digital X-ray detector handle 600 can be more readily matched to any digital X-ray detector without regard to the specific requirements in data communication speed or power requirements of the digital X-ray detector.

Some implementations of digital X-ray detector handles 500 and 600 include a battery-status indicator. The battery-status indicator (not shown) is operable to indicate an amount of charge of the battery, such as battery 508. In some implementations, the battery-status indicator indicates which portion of a full-charge of the battery is charged. For example, the entire battery-status indicator is fully lighted to indicate that the battery is fully charged, the battery-status indicator is completely unlighted to indicate that the battery has no charge, and the battery-status indicator is lighted halfway to indicate that the battery has 50% of a full-charge. In implementations where the battery-status indicator is a light, such as a light-emitting-diode (LED) light, the LED is fully-lighted to indicate a full-charge in the battery, the LED is unlighted to indicate no charge in the battery, and the LED is half-lighted to indicate a 50% charge in the battery. In implementations where the battery-status indicator is a contiguous series of lights, such as a series of LED lights, all of the LEDs are lighted to indicate a full-charge in the battery, none of the LED are lighted to indicate no charge in the battery, and half of the LEDs are lighted to indicate a 50% charge in the battery. In some implementations, the battery-status indicator is a speaker that enunciates a tone when the battery charge level is below a particular threshold. In some implementations, a notice of low battery charge is provided through at least two levels. For example, at one level, when the remaining battery power is below a specific level (e.g. 5%), a warning is provided by the digital X-ray detector handle (500 or 600) to the operator by means, for example, audio (a particular tone from digital X-ray detector handle ) and and/or video (LED flash on detector and popup window on the screen of the handle. For example at another level, when the remaining battery power is below a 2 level (e.g. 2%), the digital X-ray detector handles 500 and 600 is powered off when the detector is not in the process of acquiring an image. Power off is delayed during image acquisition because emitting X-ray energy into a patient without obtaining an image is a safety concern to the patient.

Some implementations of digital X-ray detector handles 500 and 600 include a wireless-signal indicator. The wireless-signal indicator (not shown) is operable to indicate a strength of a wireless-signal received by the antennae 504. In some implementations, the wireless-signal indicator indicates signal strength. For example, the entire wireless-signal indicator is fully lighted to indicate that the signal strength is full, the wireless-signal indicator is completely unlighted to indicate that no signal strength, and the wireless-signal indicator is lighted halfway to indicate a signal strength of 50% of a maximum. In implementations where the wireless-signal indicator is a light, such as a LED light, the LED is fully-lighted to indicate a full signal strength, the LED is unlighted to indicate no signal strength, and the LED is half-lighted to indicate a 50% signal strength. In implementations where the wireless-signal indicator is a contiguous series of lights, such as a series of LED lights, all of the LEDs are lighted to indicate a full signal strength, none of the LED are lighted to indicate no signal strength, and half of the LEDs are lighted to indicate a 50% signal strength. In some implementations, the wireless-signal indicator is a speaker that enunciates a tone when the signal strength level is below a particular threshold. In some implementations, a notice of low signal strength is provided through at least two levels. For example, at one level, when the signal strength is below a specific level (e.g. 60%), a warning is provided by the digital X-ray detector handle (500 or 600) to the operator by means, for example, audio (a particular tone from detector or system) and and/or video (LED flash on detector and popup window on the screen of the digital X-ray detector handle.

FIG. 7 is an isometric diagram of a digital X-ray detector handle 700 having electrical contact apparatus for data and power communication with a digital X-ray detector. The digital X-ray detector handle 700 is one example or implementation of the handles in FIGS. 1, 2 and 5 above. The digital X-ray detector handle 700 includes a data interface component 702 on a face 402. The data interface component 702 is also known as a specific interface component. The data interface component 702 is mounted or attached on the exterior of the body of the digital X-ray detector handle 700. The data interface component 702 is in contact with a data interface component of an X-ray detector. The data interface component 702 of the digital X-ray detector handle 700 provides physical contact and operative electrical coupling to the specific interface component on the X-ray detector when the digital X-ray detector handle 700 is mounted on the housing of the X-ray detector.

FIG. 8 is a block diagram of a digital X-ray detector handle 800 having touchspots for data and power communication. The digital X-ray detector handle 800 is one example or implementation of the handles in FIGS. 1, 2 and 5 above. The digital X-ray detector handle 800 includes at least one power touchspot 802 on the exterior of the handle 800 and at least one data communication touchspot 804 on the exterior of the handle 800.

In some implementations, the touchspot(s) 802 and 804 are electrically and operably coupled to the battery 508 in FIG. 5 through a charging circuit (e.g. battery management component 510 in FIG. 5) and electrical path (not shown). The electrical path (not shown) provides electrical power to the battery 508 in FIG. 5 when electric power is applied to the touchspot(s) 802 and 804. The electric power can recharge the battery 508 in FIG. 5.

The touchspot(s) 802 and 804 provide a means through which the digital X-ray detector handle 800 can receive electrical power when the digital X-ray detector handle 800 is placed in a docking detector receptacle. Thus, the batterie(s) 508 in FIG. 5 of the digital X-ray detector handle 800 can be recharged during idle periods of the digital X-ray detector handle 800, which provides a convenient means of providing power to the digital X-ray detector handle 800.

In some implementations, a retractable cover (not shown) spans each of the touchspot(s) 802 and 804 to prevent dust and other contamination from coating the touchspot(s) 802 and 804. The retractable cover(s) help maintain sufficient electrical conductivity of the touchspot(s).

In some implementations, the touchspots 802 and 804 include hypoallergenic material(s), such as polyisobutene. The hypoallergenic material(s) are particularly beneficial to a digital X-ray detector handle 800 that may come in contact with a patient, or person, because the hypoallergenic material(s) reduces, if not eliminates, the possibility of the touch spots 802 and 804 causing an allergic reaction in a patient or other person such as radiological technicians, nurses or physicians that may come into physical contact with the digital X-ray detector handle 800. In some implementations, the electrical conductor(s) include only hypoallergenic materials.

In some implementations, the touchspots 802 and 804 are mounted flush to the outside 104 of the housing 102. The flush mounting of the touchspots 802 and 804 is particularly beneficial to a digital X-ray detector handle 800 that may come in contact with a patient, or person, because the flush mounting reduces, if not eliminates, the possibility of edges of the touchspots 802 and 804 catching on the skin or clothing of patients or other people such as radiological technicians, nurses or physicians, and possibly causing injury to the person or possibly acting as a deposit of human epidermis and/or blood that could be passed to a next person who comes in contact with the touchspots 802 and 804, thus acting as a medium through which viruses and/or bacteria is transmitted from one person to another. Thus, the flush mounting of the touchspots 802 and 804 prevents cross-contamination between people who have physical contact with the digital X-ray detector handle 800. In some implementations, the touchspots 802 and 804 are mounted flush within a tolerance of 0.1 millimeters of the housing 102.

In some implementations, the touchspots 802 and 804 have beveled edge(s) (not shown). The beveled edge(s) of the touchspots 802 and 804 is particularly beneficial to a digital X-ray detector handle 800 that may come in contact with a patient, or person, because the beveled edge(s) reduces, if not eliminates, the possibility of edges of the touchspots 802 and 804 catching on the skin or clothing of patients or other people such as radiological technicians, nurses or physicians, and possibly causing injury to the person or possibly acting as a deposit of human epidermis and/or blood that could be passed to the next person who comes in contact with the touchspots 802 and 804, thus acting as a medium through which viruses and/or bacteria is transmitted from one person to another. Thus, the beveled edge(s) of the touchspots 802 and 804 prevents cross-contamination between people who have physical contact with the digital X-ray detector handle 800.

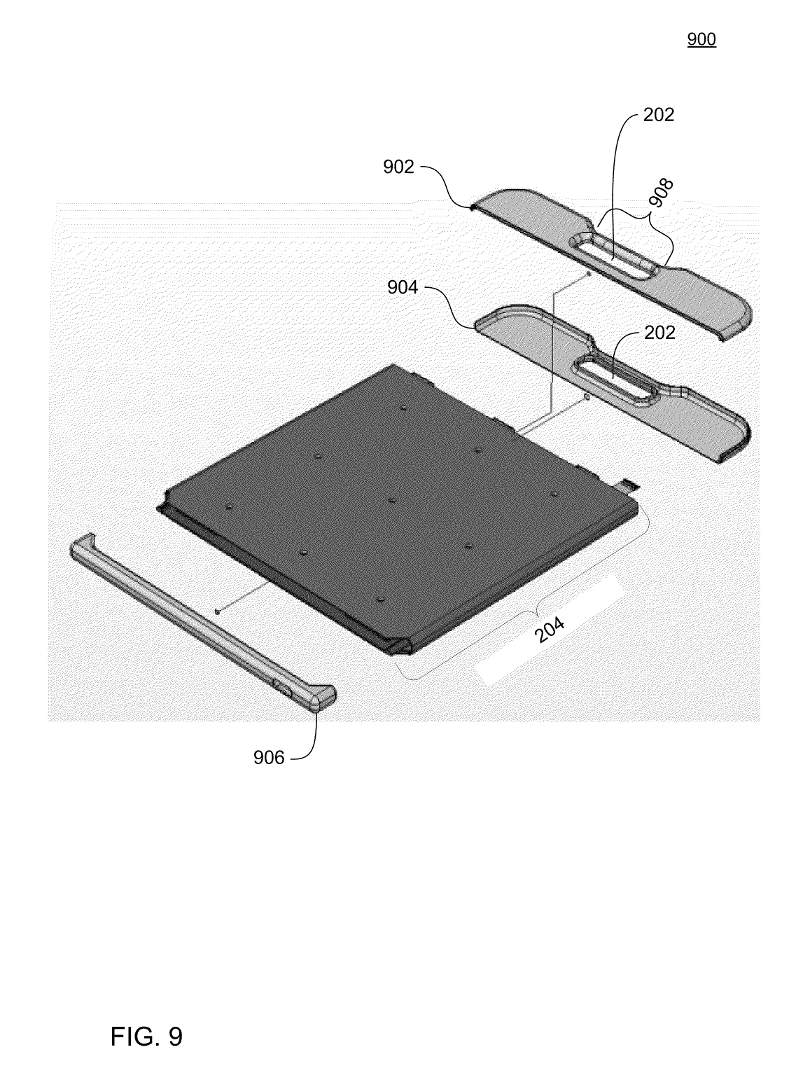

FIG. 9 is an isometric diagram of a digital X-ray detector handle 900 having a detector case. The digital X-ray detector handle 900 includes two halves 902 and 904, each halve being a recess 202 that is symmetrical to the other halve. In some implementations such as shown in FIG. 2, the recess 202 passes completely through the digital X-ray detector handle 900. The recess 202 provides convenient carriage by a human.

The digital X-ray detector handle 900 includes a detector case 204, such as a carbon fiber sleeve. The detector case 204 covers all of a digital X-ray detector when the digital X-ray detector is inserted in the detector case 204. The detector case 204 provides physical protection to the digital X-ray detector while allowing X-ray electromagnetic energy to pass through to the digital X-ray detector.

In some implementations, the detector case 204 is fixedly attached to the two halves 902 and 904. In that implementation, a digital X-ray detector slides into the sleeve 204 and the two halves 902 and 904 couple to the detector case 204.

The digital X-ray detector handle 900 also includes an end-cap 906 that can be fixedly attached to the detector case 204. When a digital X-ray detector is placed inside the detector case 204 and the end-cap 906 is fixedly attached to the detector case 204, the digital X-ray detector can be carried safely and securely by a human in which the human places his/her fingers in the recess 202 and grasps the portion 908 of the two halves 902 and 904 on the outside of the two halves 902 and 904 of the digital X-ray detector handle 900. In some implementations, the end-cap 906 and the detector case 204 are formed as one piece.

### Method Implementations

In the previous section, apparatus is described. In this section, the particular methods are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 1000-1100 are performed by a program executing on, or performed by firmware or hardware that is a part of, a microprocessor.

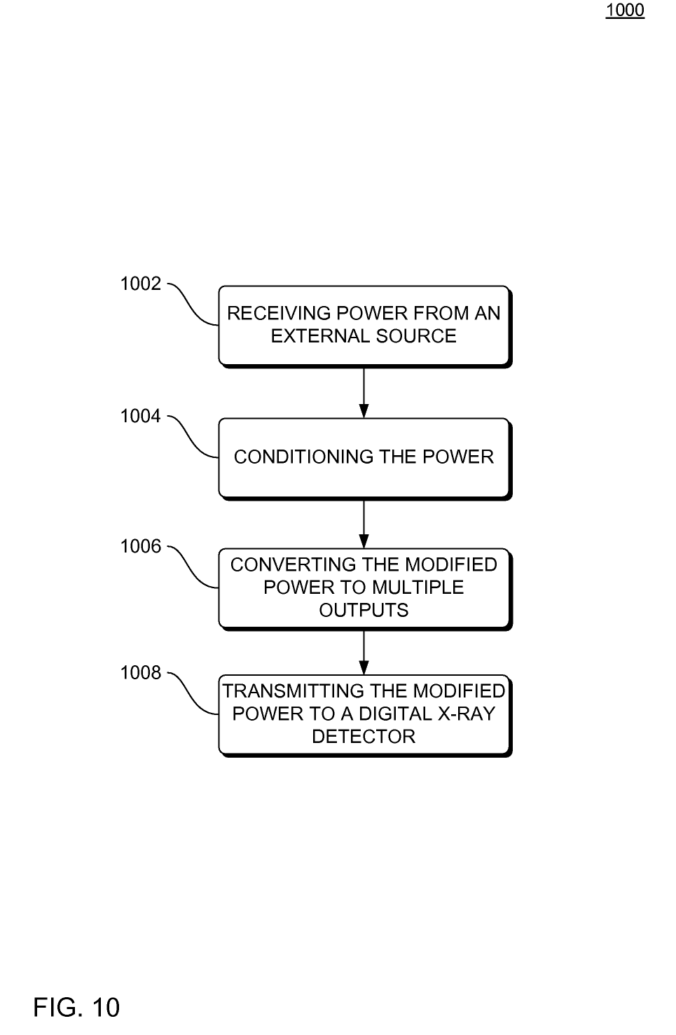

FIG. 10 is a flowchart of a method 1000 of managing electrical power, performed by a digital X-ray detector handle according to an implementation in which the handle includes a tether or docking mechanism. Method 1000 provides intermediary function between a digital X-ray detector and an external device such as an imaging station or a mobile digital X-ray imaging system. Method 1000 can be performed by a switch regulation board (SRB) (506 in FIG. 5) or other regulation circuit.

Method 1000 includes receiving power from an external source, at block 1002. Again, the external source is a conventional source, such as an imaging station or a mobile digital X-ray imaging system. A single input voltage provides simplicity of the input supply and less wiring or pins in implementations of the docking touch spots (see FIG. 8) or tether (see FIG. 4). The received power is similar to the power received from a typical wall outlet, which is usually noisier than the maximum amount of electrical noise that is acceptable. so in order to reduce the amount of noise in the received power. method 1000 thereafter also includes conditioning or modifying the received power for consumption by a digital X-ray detector, at block 1004. Some implementations of method 1000 also includes converting the single input voltage into several different outputs that are required by the detector, at block 1006. Method 1000 also includes transmitting the modified power to a digital X-ray detector, at block 1008. The transmitting 1008 can be performed, before, during or after receiving 1002 the power from the external source. When the transmitting 1008 is performed, before or after receiving 1002 the power from the external source, the method requires storage of the received or the modified electrical power. In a variation of method 1000 in which the handle includes a wireless connection, the conditioned power of action 1004 is stored in a battery, and upon demand, the battery power is converted to multiple outputs in action 1006.

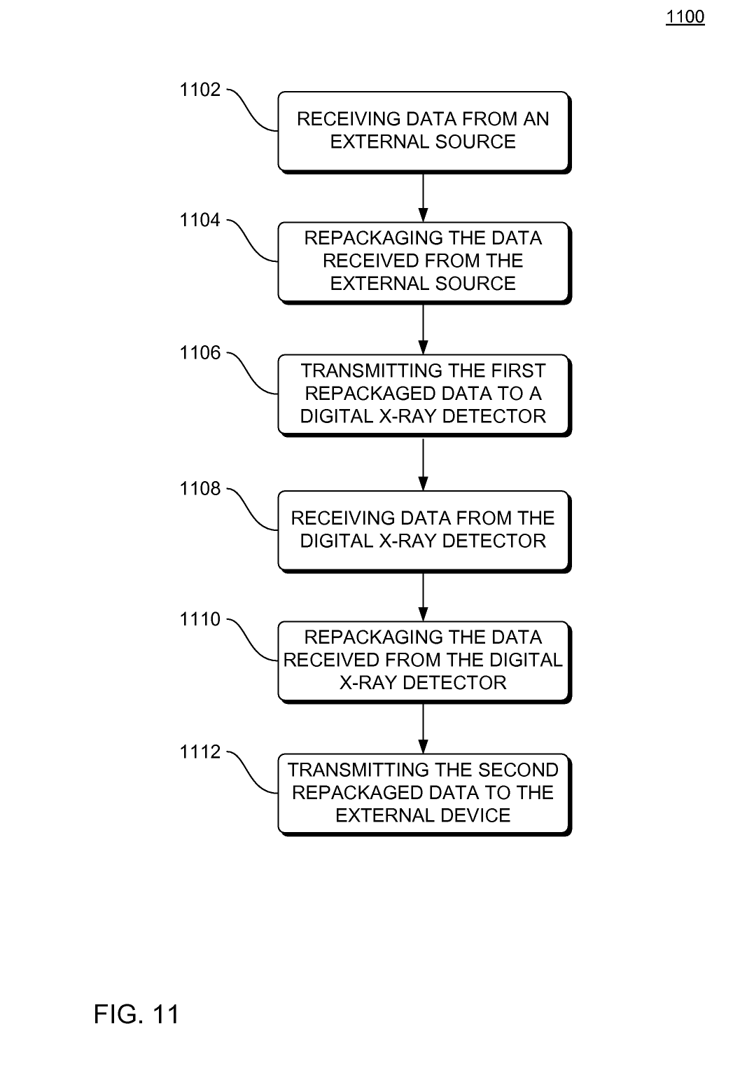

FIG. 11 is a flowchart of a method 1100 of managing data communication, performed by a digital X-ray detector handle according to an implementation. Method 1100 provides intermediary function between a digital X-ray detector and an external device such as an imaging station or a mobile digital X-ray imaging system.

Method 1100 also includes receiving data from the external source, at block 1102, thereafter repackaging the received data for suitability of use by a digital X-ray detector, at block 1104, and transmitting the repackaged to the digital X-ray detector, at block 1112. For example, the handle receives a command from an imaging station and sends a response and an image to the imaging station.

Method 1100 also includes receiving data from the digital X-ray detector, at block 1108, thereafter repackaging the received data, at block 1110, and transmitting the repackaged to the external device, at block 1112. After receiving the command, the detector translates the command into a set of actions and performs the actions. The repackaging 1110 is communication protocol specific. Generally speaking, the repackaging includes separating, for instance, one or more rows of the pixel data into small pieces, adding identification of each piece, and feeding the identified pieces into a communication line to the external device. A communication module in the handle creates a packet out of each piece of data by adding headers and tails, and then the communication module modulates the packets into analog waveforms, and transmits the analog waveform packets to the external device.

In some implementations, methods 1000-1100 are implemented as a sequence of instructions which, when executed by a processor, such as a processor, cause the processor to perform the respective method. In other implementations, methods 1000-1100 are implemented as a computer-accessible medium having executable instructions capable of directing a processor to perform the respective method. In varying implementations, the medium is a magnetic medium, an electronic medium, or an optical medium.

The following description provides an overview of computer hardware and a suitable computing environment in conjunction with which some implementations can be implemented. Implementations are described in terms of a computer executing computer-executable instructions. However, some implementations can be implemented entirely in computer hardware in which a computer-executable instructions are implemented in read-only memory.

### CONCLUSION

A modular digital X-ray detector is described. A technical effect of the digital X-ray detector handle is use of the digital X-ray detector handle one of a number of digital X-ray detectors that are designed to receive the digital X-ray detector handle. Although specific implementations have been illustrated and described herein, it will be appreciated by those of ordinary skill in the art that any arrangement which is calculated to achieve the same purpose may be substituted for the specific implementations shown. This application is intended to cover any adaptations or variations.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future portable X-ray detectors, different imaging techniques, and new data types.

1. An apparatus comprising:
a housing having an inside and an outside;
an imaging device mounted inside the housing; and
a handle that is removeably mounted to the housing, the handle having a plurality of electronic components operably coupled to the imaging device.

2. The apparatus of claim 1, wherein the imaging device further comprises:
a pixel array panel.

3. The apparatus of claim 1, wherein:
a portion of the plurality of electronic components that are related to the pixel array are mounted in the housing; and
a portion of the plurality of electronic components that are unrelated to the pixel array are mounted in the handle.

4. The apparatus of claim 1, wherein:
the handle including a specific interface component on a face of the handle that is in close proximity to the housing;
the housing including a specific interface component on a face of the housing that is in close proximity to the handle, the specific interface component of the housing located on a face of the housing that is in close proximity to the handle in a position that provides physical contact and operative electrical coupling to the specific interface component on a face of the handle when the handle is mounted on the housing.

5. The apparatus of claim 1, wherein the handle that is removeably mounted to the housing further comprises:
a handle that is removeably mounted to the housing by at least one screw.

6. The apparatus of claim 1, wherein the handle that is removeably mounted to the housing further comprises:
a handle that is removeably mounted to the housing by at least one detector case that extends over the housing.

7. The apparatus of claim 1, wherein the handle that is removeably mounted to the housing further comprises:
a handle that is removeably mounted to the housing by at least one clamp.

8. The apparatus of claim 1, wherein the handle further comprises:
a recess that passes completely through the handle.

9. The apparatus of claim 1 further comprising:
a battery electrically coupled to the plurality of electronic components and the panel.

10. A digital X-ray detector handle comprising:
a face that is operable to mount removeably to a housing of a digital X-ray detector;
a specific interface component that is operable to communicate with electronic components in the housing of the digital X-ray detector in regards to application-dependent functions of the electronic components;
a power interface that is operable to provide electrical power to electronic components in the housing of the digital X-ray detector; and
a specific interface component that is operable to communicate with electronic components not in the housing of the digital X-ray detector in regards to application-independent functions of the electronic components.

11. The digital X-ray detector handle of claim 10, wherein the specific interface component is located on the face and in close proximity to the housing in a position that provides physical contact and provides operative electrical coupling to the housing when the handle is mounted on the housing.

12. The digital X-ray detector handle of claim 10, further comprising:
a recess that passes completely through the handle.

13. The digital X-ray detector handle of claim 10, further comprising:
a detector case.

14. The digital X-ray detector handle of claim 10, wherein the detector case further comprises:
a carbon fiber sleeve.

15. The digital X-ray detector handle of claim 10, wherein the specific interface component that is operable to communicate with electronic components not in the housing further comprises:
an Ethernet communication board.

16. The digital X-ray detector handle of claim 10, wherein the specific interface component that is operable to communicate with electronic components not in the housing further comprises:
a wireless communication interface, an antennae, a switch regulation board, a battery and a battery management component.

17. The digital X-ray detector handle of claim 10, further comprising:
a power touchspot on the exterior of the handle; and
a data communication touchspot on the exterior of the handle.

18. A portable digital X-ray detector comprising:
a housing having an inside and an outside;
an imaging device mounted inside the housing;
an end-cap mounted to an end of the housing;
a handle that is removeably mounted to an end the is opposite to the end-cap of the housing, the handle having a recess that passes completely through the handle;
a plurality of electronic components operably coupled to the imaging device, wherein:
a portion of the plurality of electronic components that are dependent on the pixel array are mounted in the housing; and
a portion of the plurality of electronic components that are independent of the pixel array are mounted in the handle.

19. The portable digital X-ray detector of claim 18, further comprising:
at least one power touchspot on the exterior of the handle; and
at least one data communication touchspot on the exterior of the handle.

20. The portable digital X-ray detector of claim 18, further comprising:
a detector case.

21. The portable digital X-ray detector of claim 18, wherein the portion of the plurality of electronic components that are independent of the pixel array further comprises:
an Ethernet communication board, a wireless communication interface, an antennae, a switch regulation board, a battery and a battery management component.

22. The portable digital X-ray detector of claim 21 further comprising:
a wireless signal indicator.

23. The portable digital X-ray detector of claim 21 further comprising:
a battery-status indicator.

24. A digital detector comprising:
a housing;
an imaging panel mounted within the housing; and
a handle removeably mounted to the housing, the handle having a plurality of electronic components operably coupled to the imaging panel.

25. The digital detector of claim 24, wherein:
a portion of the plurality of electronic components that are related to the pixel array are mounted within the housing.

26. The digital detector of claim 24, wherein:
a portion of the plurality of electronic components that are unrelated to the pixel array are mounted in the handle.

27. The digital detector of claim 24, wherein the handle further comprises:
a specific interface component on a face of the handle that is in close proximity to the housing when the handle is mounted to the housing.

28. The digital detector of claim 27, wherein the housing further comprises:
a specific interface component on a face of the housing that is in close proximity to the handle when the handle is mounted to the housing, the specific interface component of the housing located on a face of the housing that is in close proximity to the handle in a position that provides physical contact and operative electrical coupling to the specific interface component on a face of the handle when the handle is mounted on the housing.
